(19) United States
(12) Patent Application Publication
(10) Pub. No.: US 2026/0125521 A1
(43) Pub. Date: May 7, 2026

(54) TUBE AND METHOD FOR MAKING SAME

(71) Applicant: SAINT-GOBAIN PERFORMANCE PLASTICS CORPORATION, Malvern, PA (US)

(72) Inventors: Zichao WEI, Brighton, MA (US); Shuai Liang, Southborough, MA (US); Michael J. Tzivanis, Chicopee, MA (US); Jiezhu Jin, Westborough, MA (US); Hua Wang, Northbridge, MA (US); Kendra R. Watson, Berlin, MA (US)

(21) Appl. No.: 19/380,494

(22) Filed: Nov. 5, 2025

Related U.S. Application Data
(60) Provisional application No. 63/716,428, filed on Nov. 5, 2024.

(51) Int. Cl. C08J 3/22; C08G 77/00; C08G 77/08; C08K 3/36; C08K 7/14

(52) U.S. Cl. CPC C08J 3/22; C08G 77/08; C08G 77/70; C08K 3/36; C08K 7/14

(57) ABSTRACT

A tube includes: a substrate including a sidewall defining a lumen profile along a central axis, where the substrate includes a composition including a silicone polymer, an inorganic filler, a cross-linking component, and a catalyst, where the tube has a minimum yield strain of 5%, where the tube has a minimum tensile strength of 12 MPa, where the tube has a minimum tear strength of 15 N/mm, where the tube has a minimum toughness of 0.26 MPa, and where the tube has a minimum tensile modulus of 120 MPa.

### CROSS-REFERENCE TO RELATED APPLICATION(S)

This application claims priority under 35 U.S.C. § 119(e) to U.S. Provisional Patent Application No. 63/716,428 entitled “TUBE AND METHOD FOR MAKING SAME,” filed Nov. 5, 2024, by Zichao W E I et al., which is assigned to the current assignee hereof and is incorporated herein by reference in its entirety.

### FIELD OF THE DISCLOSURE

This application in general relates to a tube and a method for making the same, and in particular, relates to a conduit for a medical tubing.

### BACKGROUND

Composite materials including a composition of substrates and fillers are generally known to be made into tubing for housing and moving fluid in applications such as, but not limited to, pharmaceutical manufacturing, personal care, medical device, food and beverage, fluid transfer, aerospace, vehicle, or habitat industry applications. Conventionally, in these applications, polymers were used as substrates for tubing due to their low toxicity and outstanding heat and chemical resistance performance. However, polymers have drawbacks regarding sustainability and biocompatibility. As a result, there is an ongoing need for improved composite materials for tubing having optimal values in chemical inertness, biocompatibility, elasticity, coefficient of friction, contamination resistance, and other mechanical properties, while maintaining heat and chemical resistance for their desired application.

### SUMMARY

In a number of embodiments, a tube includes: a substrate forming a sidewall defining a lumen profile along a central axis, wherein the substrate includes a composition including a silicone polymer, an inorganic filler, a cross-linking component, and a catalyst, where the tube has a minimum yield strain of 5%, where the tube has a minimum tensile strength of 12 MPa, where the tube has a minimum tear strength of 15 N/mm, where the tube has a minimum toughness of 0.26 MPa, and where the tube has a minimum tensile modulus of 120 MPa.

In another embodiment, a method includes: providing a substrate including a composition including a silicone polymer, an inorganic filler, a cross-linking component, and a catalyst; and forming a sidewall from the substrate, the sidewall defining a lumen profile along a central axis to form a tube, where the tube has a minimum yield strain of 5%, where the tube has a minimum tensile strength of 12 MPa, where the tube has a minimum tear strength of 15 N/mm, where the tube has a minimum toughness of 0.26 MPa, and where the tube has a minimum tensile modulus of 120 MPa.

### BRIEF DESCRIPTION OF THE DRAWINGS

The present disclosure may be better understood, and its numerous features and advantages made apparent to those skilled in the art by referencing the accompanying drawings.

FIG. 1A includes an illustration of an exemplary tube according to an embodiment.

FIG. 1B includes an illustration of an exemplary tube according to an embodiment.

The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having” or any other variation thereof, are open-ended terms and should be interpreted to mean “including, but not limited to . . . ” These terms encompass the more restrictive terms “consisting essentially of” and “consisting of.” In a number of embodiments, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the tubing structural arts and corresponding manufacturing arts. Unless indicated otherwise, all measurements are at about 23° C.+/−5° C. per ASTM.

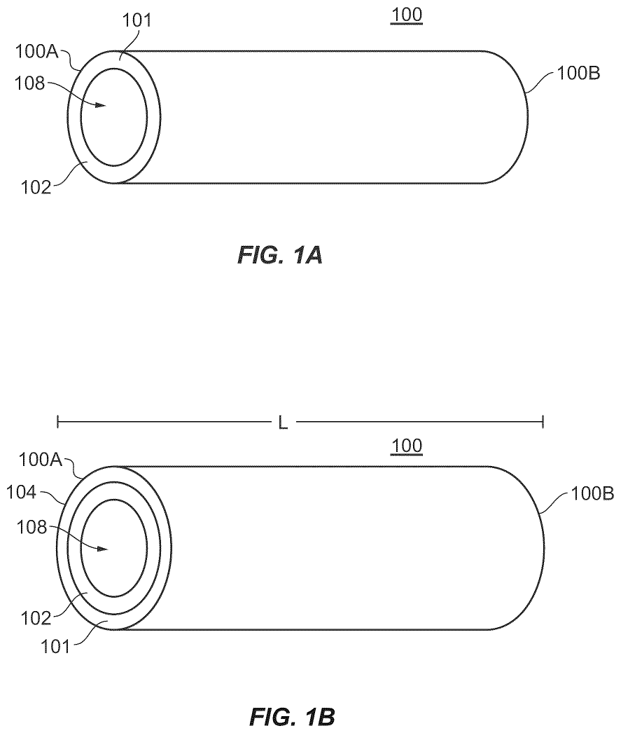

FIGS. 1A-1B illustrate a tube according to a number of embodiments. As shown in FIG. 1A, the tube 100 may include a sidewall 101 formed of a substrate 102 forming a lumen profile 108 of the tube 100. In a number of embodiments, as shown in FIG. 1B, the tube 100 may include a coating 104 overlying or underlying the substrate 102. In a number of embodiments, the coating 104 may be formed on an interior side of the sidewall 101. In a number of embodiments, the coating 104 may be formed on an exterior side of the sidewall 101. In a number of embodiments, the coating 104 may directly contact the sidewall 101 and/or be directly bonded to the sidewall 101. In a number of embodiments, the coating 104 may surround the sidewall 101. In a number of embodiments, the tube 100 consists essentially of the substrate 102. As used herein, the phrase “consists essentially of” used in connection with the tube 100 precludes the presence of other layers that affect the basic and novel characteristics of the tube 100. In yet another embodiment, the tube 100 may further include additional layers (not illustrated). Any additional layer may be envisioned such as an additional tie layer, a polymeric layer, or combination thereof. Any position of the additional layer on the tube 100 is envisioned. When the tube 100 includes multiple layers, any order of providing the layers together or individually is envisioned.

The substrate 102 and/or tube 100 has a thickness t₁. In a number of embodiments, t₁ can be at least 0.025 mm, at least 0.050 mm, at least 0.100 mm, at least 0.500 mm, at least 1 mm, at least 2 mm, at least 3 mm, at least 4 mm, at least 5 mm, at least 6 mm, at least 8 mm, at least 10 mm, at least 50 mm, at least 80 mm, at least 100 mm, at least 150 mm, at least 200 mm, or at least 300 mm. In another embodiment, t₁ can be not greater than 800 mm, not greater than 700 mm, not greater than 650 mm, not greater than 600 mm, not greater than 550 mm, not greater than 500 mm, not greater than 480 mm, not greater than 460 mm, not greater than 440 mm, or not greater than 420 mm. In yet one further embodiment, t₁ ranges from 50 mm to 800 mm, such as from 100 mm to 600 mm, from 200 mm to 500 mm, or from 300 mm to 450 mm. In one particular embodiment, t₁ ranges from 380 mm to 420 mm. It will be further appreciated that the substrate 102 may have a thickness, t₁, that may be any value between any of the minimum and maximum values noted above. It can also be appreciated that the substrate 102 and/or tube 100 has a thickness, t₁, that may vary along its length. It can also be appreciated that the substrate 102 and/or tube 100 has a thickness, t₁, that may be uniform along its axial length.

The tube 100 can have an inner diameter (or smallest dimension), ID, where the inner diameter is at least 0.1 mm, at least 1 mm, at least 1.5 mm, at least 2 mm, at least 5 mm, at least 10 mm, at least 25 mm, at least 50 mm, at least 100 mm, at least 200 mm, at least 250 mm, or at least 500 mm. The tube 100 can have an inner diameter (or smallest dimension), ID, where the inner diameter is not greater than 1000 mm, not greater than 500 mm, not greater than 250 mm, not greater than 200 mm, or not greater than 100 mm. The tube 100 can have an inner diameter (or smallest dimension), ID, where the inner diameter is in a range from 0.1 mm to 250 mm, in a range from 1 mm to 200 mm, in a range from 1 mm to 150 mm, or in a range from 1 mm to 125 mm. It will be further appreciated that tube 100 can have an inner diameter (or smallest dimension), ID, that may be any value between any of the minimum and maximum values noted above. It can also be appreciated that tube 100 can have an inner diameter (or smallest dimension), ID, that may be uniform along its length. The tube 100 can have an inner diameter (or smallest dimension), ID, that varies along a length of the tube 100.

The tube 100 can have an outer diameter (or largest dimension), OD, where the outer diameter is at least 0.1 mm, at least 0.2 mm, at least 0.5 mm, at least 1 mm, at least 1.8 mm, at least 2 mm, at least 5 mm, at least 10 mm, at least 25 mm, at least 50 mm, at least 100 mm, at least 200 mm, at least 250 mm, or at least 500 mm. The tube 100 can have an outer diameter (or largest dimension), OD, where the outer diameter is not greater than 1000 mm, not greater than 500 mm, not greater than 250 mm, not greater than 200 mm, or not greater than 100 mm. The tube 100 can have an outer diameter (or largest dimension), OD, where the outer diameter is in a range from 1 mm to 250 mm, in a range from 1 mm to 200 mm, in a range from 5 mm to 150 mm, or in a range from 5 mm to 125 mm. The tube 100 can have an outer diameter (or largest dimension), OD, that varies along a length of the tube 100. It will be further appreciated that tube 100 can have an outer diameter (or largest dimension), OD, that may be any value between any of the minimum and maximum values noted above. It can also be appreciated that tube 100 can have an outer diameter (or largest dimension), OD, that may be uniform along its length. The tube 100 can have an outer diameter (or largest dimension), OD, that varies along a length of the tube 100.

According to a number of embodiments, the tube 100 may have a length, L, extending from a first end 100A to a second end 100B. In a number of embodiments, the lumen profile 108 may have a profile through which a fluid may be carried, pumped, or otherwise transported through that may be essentially constant throughout the length, L, of the tube 100. In a number of embodiments, the lumen profile 108 may have a profile that may be non-uniform or non-constant throughout the length, L, of the tube 100. In a number of embodiments, the lumen profile 108 may define an inner profile while the outer surface of the tube (e.g. lumen profile) may define an outer profile along the length, L, of the tube 100. In a number of embodiments, the inner profile may be coaxial with the outer profile along the length, L, of the tube 100. In a number of embodiments, the inner profile may be not coaxial with the outer profile along the length, L, of the tube 100. In a number of embodiments, the inner profile may be incongruous with outer profile along the length, L, of the tube 100. In a number of embodiments, the lumen profile 108 may have a uniform diameter. In a number of embodiments, the lumen profile 108 may have a non-uniform diameter. In a number of embodiments, the lumen profile 108 may have a geometric shape. In a number of embodiments, the lumen profile 108 may have a geometric shape comprising a polygon. In a number of embodiments, the lumen profile 108 may have a geometric shape comprising a regular polygon or a non-regular polygon. In a number of embodiments, the lumen profile 108 may have a geometric shape comprising a circle, ellipse, or oval. The tube 100 can have a geometric shape that varies along a length of the tube 100.

In a number of embodiments, the substrate 102 or tube 100 can be comprised of a composition. In a number of embodiments, the composition can include a polymer matrix. In a number of embodiments, the polymer of the polymer matrix may be any polymer with desirable mechanical and optical properties is envisioned. An exemplary polymer may be formed of a homopolymer, copolymer, terpolymer, or polymer blend formed from at least one of a silicone polymer, a polyolefin, a polycarbonate, a cellulose triacetate, a cellulose ester, a polymethyl methacrylate, an epoxy, a cyclic olefin copolymer, a silicone (including an Si—H containing polymer including Si—H functionalization ranges from 1-100 mol %), a polyvinyl chloride, an amorphous copolyester, a polyethylene terephthalate, an ionomer resin, an acrylonitrile butadiene styrene (ABS), a styrene methyl methacrylate, a polystyrene, a blend, or combination thereof. In a number of embodiments, the polymer may include a polyolefin. Any reasonable polyolefin is envisioned. For instance, the polyolefin includes a polymethyl pentene (TPX), a polypropylene (PP), polyethylene (PE), a blend, or combination thereof. In particular embodiments, the polymer may include a cyclic block co-polymer. In particular embodiments, the polymer may include a polyolefin block co-polymer or a cyclic olefinic co-polymer. In particular embodiments, the polymer may include a silicone polymer comprising MQ resin.

In a number of embodiments, the composition of the substrate 102 or tube 100 may have a content of polymer of at least 20 wt. %, at least 30 wt. %, at least 40 wt. %, at least 50 wt. %, at least 60 wt. %, at least 70 wt. %, at least 75 wt. %, at least 80 wt. %, at least 85 wt. %, or at least 90 wt. %, or at least 95 wt. %, or at least 99 wt. %. In a number of embodiments the composition of the substrate 102 or tube 100 may have a content of polymer of no greater than 99 wt. %, no greater than 95 wt. %, no greater than 90 wt. %, no greater than 80 wt. %, no greater than 75 wt. %, no greater than 60 wt. %, no greater than 50 wt. %, no greater than 35 wt. %, no greater than 25 wt. %, no greater than 15 wt. %, no greater than 10 wt. %, no greater than 5 wt. %, or no greater than 1 wt. %. It will be further appreciated that the composition of polymer may have a wt. % of polymer that may be any value between any of the values noted above.

In a number of embodiments, the polymer matrix of the composition may be crosslinked. Although not being bound by theory, crosslinking may increase the crosslinks within the polymer matrix. In a number of embodiments, crosslinking of the polymer matrix improves the tensile modulus of the final tube, as described below. In a number of embodiments, the crosslink density may be tuned to minimize the polymeric material's ability to swell in alcohol and/or increase its mechanical properties. Any reasonable method of crosslinking is envisioned. For instance, the polymer matrix may be cross-linked via radiation such as via ultraviolet radiation, electron-beam radiation, gamma radiation, or combination thereof. In a number of embodiments, the radiation includes electron beam radiation. In a number of embodiments, the electron beam radiation is at 30 kGy to 750 kGy. In another embodiment, the electron beam radiation is at 100 kGy to 300 kGy. It will be appreciated that the radiation can be within a range between any of the minimum and maximum values noted above.

Methods of crosslinking may be dependent on the polymer matrix chosen. In an example, the polymer matrix is a silicone polymer. When the polymer matrix is a silicone polymer, the crosslink reaction could be either thermal cured, or using acrylic functionalized silicone polymer, cured by UV light. In an example, the platinum method formulation will be prepared based on a modified commercial package and UV cured. The method of crosslinking may be prior to or after forming the tube. For instance, the silicone polymer can be partially crosslinked prior to extrusion and then extruded into a final product, such as the tube 100. In another embodiment, the silicone polymer can be extruded and then crosslinked.

In a number of embodiments, the composition of the tube may include a cross-linking component. The cross-linking component may include a polymer, metal, ceramic, or any combination thereof. In an embodiment, the cross-linking component may include interpenetrating crosslinking networks, the interpenetrating crosslinking networks including covalent and noncovalent dynamic bonding between the polymer matrix and the catalyst.

In a number of embodiments, the composition of the substrate 102 or tube 100 may have a content of cross-linking component of at least 20 wt. %, at least 30 wt. %, at least 40 wt. %, at least 50 wt. %, at least 60 wt. %, at least 70 wt. %, at least 75 wt. %, at least 80 wt. %, at least 85 wt. %, or at least 90 wt. %, or at least 95 wt. %, or at least 99 wt. %. In a number of embodiments the composition of the substrate 102 or tube 100 may have a content of cross-linking component of no greater than 99 wt. %, no greater than 95 wt. %, no greater than 90 wt. %, no greater than 80 wt. %, no greater than 75 wt. %, no greater than 60 wt. %, no greater than 50 wt. %, no greater than 35 wt. %, no greater than 25 wt. %, no greater than 15 wt. %, no greater than 10 wt. %, no greater than 5 wt. %, or no greater than 1 wt. %. It will be further appreciated that the composition of cross-linking component may have a wt. % of cross-linking component that may be any value between any of the values noted above.

In a number of embodiments, the tube 100 according to embodiments herein may have a cross-link density of at least 0.1 mol/cm³, at least 0.5 mol/cm³, at least 1 mol/cm³, at least 10 mol/cm³, at least 25 mol/cm³, at least 50 mol/cm³, at least 100 mol/cm³, at least 150 mol/cm³, at least 250 mol/cm³, or at least 500 mol/cm³. In some embodiments, tube 100 according to embodiments herein may have a cross-link density of not greater than 1500 mol/cm³, not greater than 1250 mol/cm³, not greater than 1000 mol/cm³, not greater than 750 mol/cm³, not greater than 500 mol/cm³, not greater than 400 mol/cm³, not greater than 300 mol/cm³, not greater than 200 mol/cm³, or not greater than 100 mol/cm³. Further, it will be appreciated that the tube 100 according to embodiments herein may have a cross-link density between any of these minimum and maximum values, such as at least 25 mol/cm³ to not greater than 1500 mol/cm³, at least 25 mol/cm³ to not greater than 500 mol/cm³, or even at least 25 mol/cm³ to not greater than 100 mol/cm³. It will be further appreciated that the tube 100 according to embodiments herein may have a cross-link density that may be any value between any of the minimum and maximum values noted above. In a number of embodiments, the type of cross-linking component may be optimized to mitigate micro-cracking during applied force to provide better mechanical property performance as described herein.

In a number of embodiments, the composition of the substrate 102 or tube 100 can include a catalyst. The catalyst may include a rigid material such as, but not limited to, a metal. According to certain embodiments, the metal may include iron, copper, titanium, tin, aluminum, platinum, palladium, titanium, alloys thereof, an anodized metal (including the metals listed), or any combination thereof. In specific embodiments, the catalyst may include a platinum (Pt) based catalyst. In specific embodiments, the catalyst may include a platinum (Pt) based masterbatch catalyst.

In a number of embodiments, the composition of the substrate 102 or tube 100 may have a content of catalyst of at least 0.1 wt. %, at least 0.5 wt. %, at least 1 wt. %, at least 5 wt. %, at least 10 wt. %, 20 wt. %, at least 30 wt. %, at least 40 wt. %, at least 50 wt. %, at least 60 wt. %, at least 70 wt. %, at least 75 wt. %, at least 80 wt. %, at least 85 wt. %, or at least 90 wt. %, or at least 95 wt. %, or at least 99 wt. %. In a number of embodiments the composition of the substrate 102 or tube 100 may have a content of catalyst of no greater than 99 wt. %, no greater than 95 wt. %, no greater than 90 wt. %, no greater than 80 wt. %, no greater than 75 wt. %, no greater than 60 wt. %, no greater than 50 wt. %, no greater than 35 wt. %, no greater than 25 wt. %, no greater than 15 wt. %, no greater than 10 wt. %, no greater than 5 wt. %, or no greater than 1 wt. %. It will be further appreciated that the composition of catalyst may have a wt. % of catalyst that may be any value between any of the values noted above.

In a number of embodiments, the composition of the substrate 102 or tube 100 can include a filler. In a number of embodiments, the composition of the tube may include any filler envisioned. The filler may include, for example, a curing agent, an antioxidant, a filler, an ultraviolet (UV) agent, an absorber, a curing agent, a dye, a pigment, an anti-aging agent, a plasticizer, the like, or combination thereof. In a number of embodiments, the curing agent is a cross-linking agent provided to increase and/or enhance crosslinking of the polymer matrix material. In a further embodiment, the use of a curing agent may provide desirable properties such as decreased permeation of small molecules and improved elastic recovery of the material compared to a material that does not include a curing agent. Any curing agent is envisioned and depends on the polymer matrix material chosen. The curing agent may be, for example, a dihydroxy compound, a diamine compound, an organic peroxide, a hydride, platinum, tin, or combination thereof. An exemplary dihydroxy compound includes a bisphenol AF. An exemplary diamine compound includes hexamethylene diamine carbamate. In a number of embodiments, the curing agent is an organic peroxide. Any amount of curing agent is envisioned. Alternatively, the polymer matrix material may be substantially free of crosslinking agents, curing agents, photoinitiators, fillers, plasticizers, or a combination thereof. “Substantially free” as used herein refers to less than about 1.0% by weight, or even less than about 0.1% by weight of the total weight of the polymer matrix. In a number of embodiments, the filler may include at least one of alumina, silica, titanium dioxide, calcium fluoride, boron nitride, mica, wollastonite, glass fibers, silicon carbide, silicon nitride, zirconia, carbon black, pigments, or any combination thereof.

The filler may include, for example, a curing agent, an antioxidant, a filler, an ultraviolet (UV) agent, an absorber, a curing agent, a dye, a pigment, an anti-aging agent, a plasticizer, the like, or combination thereof. In a number of embodiments, the curing agent is a cross-linking agent provided to increase and/or enhance crosslinking of the polymer matrix material. In a further embodiment, the use of a curing agent may provide desirable properties such as decreased permeation of small molecules and improved elastic recovery of the material compared to a material that does not include a curing agent. Any curing agent is envisioned and depends on the polymer matrix material chosen. The curing agent may be, for example, a dihydroxy compound, a diamine compound, an organic peroxide, a hydride, platinum, tin, or combination thereof. An exemplary dihydroxy compound includes a bisphenol AF. An exemplary diamine compound includes hexamethylene diamine carbamate. In a number of embodiments, the curing agent is an organic peroxide. Any amount of curing agent is envisioned. Alternatively, the polymer matrix material may be substantially free of crosslinking agents, curing agents, photoinitiators, fillers, plasticizers, or a combination thereof. “Substantially free” as used herein refers to less than about 1.0% by weight, or even less than about 0.1% by weight of the total weight of the polymer matrix. In a number of embodiments, the filler may include at least one of least one of alumina, silica (e.g. fumed, high specific surface area (“SSA”) silica), titanium dioxide, calcium fluoride, boron nitride, mica, wollastonite, glass fibers, silicon carbide, silicon nitride, zirconia, carbon black, pigments, or any combination thereof.

In a number of embodiments, the composition of the substrate 102 or tube 100 may have a content of filler of at least 1 wt. %, at least 5 wt. %, at least 10 wt. %, at least 15 wt. %, 20 wt. %, at least 30 wt. %, at least 40 wt. %, at least 50 wt. %, at least 60 wt. %, at least 70 wt. %, at least 75 wt. %, at least 80 wt. %, at least 85 wt. %, or at least 90 wt. %, or at least 95 wt. %, or at least 99 wt. %. In a number of embodiments the composition of the substrate 102 or tube 100 may have a content of filler of no greater than 99 wt. %, no greater than 95 wt. %, no greater than 90 wt. %, no greater than 80 wt. %, no greater than 75 wt. %, no greater than 60 wt. %, no greater than 50 wt. %, no greater than 35 wt. %, no greater than 25 wt. %, no greater than 15 wt. %, no greater than 10 wt. %, no greater than 5 wt. %, or no greater than 1 wt. %. It will be further appreciated that the composition of filler may have a wt. % of filler that may be any value between any of the values noted above.

In a number of embodiments, the tube 100 according to embodiments herein may have a filler surface area of at least 25 m²/g, at least 50 m²/g, at least 75 m²/g, at least 100 m²/g, at least 200 m²/g, at least 300 m²/g, at least 400 m²/g, at least 500 m²/g, at least 750 m²/g, or at least 1000 m²/g. In some embodiments, tube 100 according to embodiments herein may have a filler surface area of not greater than 1500 m²/g, not greater than 1250 m²/g, not greater than 1000 m²/g, not greater than 750 m²/g, not greater than 500 m²/g, not greater than 400 m²/g, not greater than 300 m²/g, not greater than 200 m²/g, or not greater than 100 m²/g. Further, it will be appreciated that the tube 100 according to embodiments herein may have a filler surface area between any of these minimum and maximum values, such as at least 25 m²/g to not greater than 1500 m²/g, at least 25 m²/g to not greater than 500 m²/g, or even at least 25 m²/g to not greater than 100 m²/g. It will be further appreciated that the tube 100 according to embodiments herein may have a filler surface area that may be any value between any of the minimum and maximum values noted above. In a number of embodiments, the amount of filler (e.g. fumed, high surface area silica with 150-360 m²/g high specific surface area) may be optimized to mitigate micro-cracking during applied force and dissipate stress concentrations to provide better mechanical property performance as described herein.

In a number of embodiments, the substrate 102 may be provided by any method envisioned and is dependent upon the polymer matrix material chosen. In a number of embodiments, the polymer matrix material is melt processable. “Melt processable” as used herein refers to a polymer material that can melt and flow to extrude in any reasonable form such as films, tubes, fibers, molded articles, or sheets. For instance, the melt processable polymer material is a flexible material. In a number of embodiments, the polymer matrix of the substrate 102 is extruded, injection molded, or mandrel wrapped. In an exemplary embodiment, the polymer matrix of the substrate 102 is extruded. The polymer matrix of the substrate 102 may be cured in place using a variety of curing techniques such as via heat, radiation, or any combination thereof, such as extrusion, molding, or blow molding. In a number of embodiments, at least one of the substrate 102 or tube 100 can be formed in a desired shape using any common techniques known in the art, including, but not limited to, cutting, forging, rolling, flanging, chamfering, turning, reaming, extruding, molding, sintering, or casting. As a result of the manufacturing process, the substrate 102 or tube 100 may exhibit covalent dynamic bonding due to the bond reformation under force dissipating the energy, which increases flexibility, tensile strength, and tear strength.

In a number of embodiments, any post-cure steps may be envisioned. In particular, the post-cure step includes any thermal treatment, radiation treatment, or combination thereof. Any thermal conditions are envisioned. In a number of embodiments, the post-cure step includes any radiation treatment such as, for example, electron beam treatment, gamma treatment, x-ray treatment, or combination thereof. In an example, the gamma radiation or ebeam radiation may be at about 62 kGy to 750 kGy. In a number of embodiments, the post-cure step may be provided to eliminate any residual volatiles, increase crosslinking, or combination thereof. It will be appreciated that the radiation can be within a range between any of the minimum and maximum values noted above. Further, in a number of embodiments, the tube 100 may be sterilized through known methods to provide a sterile tube finished product.

Referring back to FIGS. 1A-1B, as stated above, the tube 100 can include a coating 104. The coating 104 can be coated such that it overlies at least one of the interior or exterior surface of the substrate 102 or tube 100 to overlie at least a portion of the substrate 102 or tube 100. The coating 104 can be coated such that it overlies an end 100A, 100B of the substrate 102 or tube 100. In a number of embodiments, the coating 104 may include a silicon oxide, a silicon nitride, a silicon carbide, silicon oxynitride, a metal oxynitride, a metal oxide, a metal nitride, or a metal carbide, or combinations thereof. In a number of embodiments, the coating may include titanium oxide, titanium nitride, titanium carbide, zinc oxide, zinc nitride, zinc carbide, hafnium oxide, hafnium nitride, hafnium carbide, indium oxide, indium nitride, indium carbide, aluminum oxide, aluminum nitride, aluminum carbide, or combinations thereof. It is contemplated herein that the coating 104 may include multiple layers of differing compositions.

The coating 104 has a thickness, t₂. In one embodiment, t₂ can be at least 10 nm, at least 20 nm, at least 30 nm, at least 50 nm, at least 80 nm, at least 100 nm, at least 150 nm, at least 200 nm, at least 300 nm, at least 400 nm, at least 500 nm, at least 600 nm, at least 800 nm, at least 1000 nm, at least 1200 nm, at least 1400 nm, at least 1600 nm, at least 1800 nm, least 2000 nm, or even at least 5000 nm. In another embodiment, t₂ can be not greater than 5500 nm, not greater than 2500 nm, not greater than 2000 nm, not greater than 1800 nm, not greater than 1600 nm, not greater than 1400 nm, not greater than 1200 nm, not greater than 1000 nm, not greater than 800 nm, not greater than 700 nm, not greater than 650 nm, not greater than 600 nm, not greater than 550 nm, not greater than 500 nm, not greater than 480 nm, not greater than 460 nm, not greater than 440 nm, or not greater than 420 nm. In yet one further embodiment, t₂ can be in the range from 10 nm to 2000 nm, in a range from 20 nm to 1000 nm, in a range from 100 nm to 500 nm, or in a range from 100 nm to 200 nm. It will be further appreciated that coating 104 has a thickness, t₂, that may be any value between any of the minimum and maximum values noted above. It can also be appreciated that coating 104 has a thickness, t₂, that may vary along its length. It can also be appreciated that coating 104 has a thickness, t₂, that may be uniform along its axial length. The coating 104 may be applied by any method envisioned and includes, for instance, dip coating, spray coating, atmospheric plasma enhanced polymerization, film coating, or combination thereof.

In a number of embodiments, at least one surface of the substrate 102 or tube 100 may be treated to improve adhesion between the adjacent layers. Any treatment is envisioned that increases the adhesion between two adjacent layers, such as a coating 104 layer and the substrate 102. For instance, a surface of the substrate 102 that is directly adjacent to the inner layer is treated. In a number of embodiments, the surface of the substrate 102 that is directly adjacent to the outer layer is treated. In a number of embodiments, the treatment may include surface treatment, plasma treatment, corona treatment, laser treatment, chemical treatment, sodium etching, use of a primer, ion implantation, or use of or any combination thereof. In a number of embodiments, the treatment may include corona treatment, UV treatment, electron beam treatment, gamma treatment, flame treatment, scuffing, sodium naphthalene surface treatment, or any combination thereof.

In a number of embodiments, the tube 100 according to embodiments herein may include indication of an improved mechanical property including at least one of tensile modulus, toughness, Shore hardness, tensile strength, yield strain, flexural strength, tear strength, or surface roughness.

In a number of embodiments, the tube 100 according to embodiments herein may include indication of an improved mechanical property including tensile modulus as measured by ASTM D638 of at least 0.1 MPa, at least 0.5 MPA, at least 1 MPa, at least 5 MPa, at least 7.5 MPa, at least 10 MPa, at least 200 MPa, at least 300 MPa, at least 400 MPa, at least 500 MPa, at least 750 MPa, or at least 1000 MPa. In a number of embodiments, the tube 100 according to embodiments herein may include indication of an improved mechanical property including a tensile modulus of not greater than 1500 MPa, not greater than 1250 MPa, not greater than 1000 MPa, not greater than 750 MPa, not greater than 500 MPa, not greater than 400 MPa, not greater than 300 MPa, not greater than 200 MPa, or not greater than 100 MPa. In a number of embodiments, the tube 100 according to embodiments herein may include indication of an improved mechanical property including tensile modulus between any of these minimum and maximum values, such as at least 25 MPa to not greater than 1500 MPa, at least 25 MPa to not greater than 500 MPa, or even at least 25 MPa to not greater than 100 MPa. It will be further appreciated that the tube 100 according to embodiments herein may include indication of an improved mechanical property including a tensile modulus that may be any value between any of the minimum and maximum values noted above.

In a number of embodiments, the tube 100 according to embodiments herein may include indication of an improved mechanical property including toughness of at least 0.1 MPa, at least 0.26 MPa, at least 0.5 MPa, at least 1 MPa, at least 5 MPa, at least 7.5 MPa, at least 10 MPa, at least 200 MPa, at least 300 MPa, at least 400 MPa, at least 500 MPa, at least 750 MPa, or at least 1000 MPa. In a number of embodiments, the tube 100 according to embodiments herein may include indication of an improved mechanical property including a toughness of not greater than 1500 MPa, not greater than 1250 MPa, not greater than 1000 MPa, not greater than 750 MPa, not greater than 500 MPa, not greater than 400 MPa, not greater than 300 MPa, not greater than 200 MPa, or not greater than 100 MPa. In a number of embodiments, the tube 100 according to embodiments herein may include indication of an improved mechanical property including toughness between any of these minimum and maximum values, such as at least 25 MPa to not greater than 1500 MPa, at least 25 MPa to not greater than 500 MPa, or even at least 25 MPa to not greater than 100 MPa. It will be further appreciated that the tube 100 according to embodiments herein may include indication of an improved mechanical property including a toughness that may be any value between any of the minimum and maximum values noted above.

In a number of embodiments, the tube 100 according to embodiments herein may include indication of an improved mechanical property including a Shore A Hardness in a range between and including about 50 to about 100, such as in a range between about 75 to about 95, in a range between about 80 to about 90, or even in a range between about 85 to about 89. It will be further appreciated that the tube 100 according to embodiments herein may include indication of an improved mechanical property including a Shore A Hardness that may be any value between any of the minimum and maximum values noted above.

In a number of embodiments, the tube 100 according to embodiments herein may include indication of an improved mechanical property including a Shore D Hardness in a range between and including about 50 to about 100, such as in a range between about 75 to about 95, in a range between about 80 to about 90, or even in a range between about 85 to about 89. It will be further appreciated that the tube 100 according to embodiments herein may include indication of an improved mechanical property including a Shore D Hardness that may be any value between any of the minimum and maximum values noted above.

In a number of embodiments, the tube 100 according to embodiments herein may include indication of an improved mechanical property including minimum tensile strength of 5 MPa, such as 10 MPa, such as 15 MPa, such as 20 MPa. In a number of embodiments, the tube 100 according to embodiments herein may include indication of an improved mechanical property including maximum tensile strength of 500 MPa, such as 100 MPa, such as 50 MPa, such as 20 MPa. It will be further appreciated that the tube 100 according to embodiments herein may include indication of an improved mechanical property including tensile strength that may be any value between any of the minimum and maximum values noted above.

In a number of embodiments, the tube 100 according to embodiments herein may include indication of an improved mechanical property including a minimum yield strain of 5%, such as 10%, such as 15%, such as 20%, or such as 25%. In a number of embodiments, the tube 100 according to embodiments herein may include indication of an improved mechanical property including a maximum yield strain of 95%, such as 90%, such as 75%, such as 50%, or such as 40%. It will be further appreciated that the tube 100 according to embodiments herein may include indication of an improved mechanical property including a minimum yield strain that may be any value between any of the minimum and maximum values noted above.

In a number of embodiments, the tube 100 according to embodiments herein may include indication of an improved mechanical property including a flexural strength of at least 25 MPa, at least 50 MPa, at least 75 MPa, at least 100 MPa, at least 200 MPa, at least 300 MPa, at least 400 MPa, at least 500 MPa, at least 750 MPa, or at least 1000 MPa. In some embodiments, tube 100 according to embodiments herein may include indication of an improved mechanical property including a flexural strength of not greater than 1500 MPa, not greater than 1250 MPa, not greater than 1000 MPa, not greater than 750 MPa, not greater than 500 MPa, not greater than 400 MPa, not greater than 300 MPa, not greater than 200 MPa, or not greater than 100 MPa. Further, it will be appreciated that the tube 100 according to embodiments herein may include indication of an improved mechanical property including a flexural strength between any of these minimum and maximum values, such as at least 25 MPa to not greater than 1500 MPa, at least 25 MPa to not greater than 500 MPa, or even at least 25 MPa to not greater than 100 MPa. It will be further appreciated that the tube 100 according to embodiments herein may include indication of an improved mechanical property including flexural modulus that may be any value between any of the minimum and maximum values noted above.

In a number of embodiments, the tube 100 according to embodiments herein may include indication of an improved mechanical property including a tear strength of at least 10 N/mm, at least 15 N/mm, at least 25 N/mm, at least 50 N/mm, at least 75 N/mm, at least 100 N/mm, at least 200 N/mm, at least 300 N/mm, at least 400 N/mm, at least 500 N/mm, at least 750 N/mm, or at least 1000 N/mm. In some embodiments, tube 100 according to embodiments herein may include indication of an improved mechanical property including a tear strength of not greater than 1500 N/mm, not greater than 1250 N/mm, not greater than 1000 N/mm, not greater than 750 N/mm, not greater than 500 N/mm, not greater than 400 N/mm, not greater than 300 N/mm, not greater than 200 N/mm, or not greater than 100 N/mm. Further, it will be appreciated that the tube 100 according to embodiments herein may include indication of an improved mechanical property including a tear strength between any of these minimum and maximum values, such as at least 25 N/mm to not greater than 1500 N/mm, at least 25 N/mm to not greater than 500 N/mm, or even at least 25 N/mm to not greater than 100 N/mm. It will be further appreciated that the tube 100 according to embodiments herein may include indication of an improved mechanical property including tear strength that may be any value between any of the minimum and maximum values noted above.

In a number of embodiments, the tube 100 according to embodiments herein may include indication of an improved mechanical property including a surface roughness that can be at least about 0.01 micron, at least about 0.02 micron, at least about 0.05 micron, at least about 0.1 micron, at least about 0.5 micron, at least about 1 micron, at least about 2 microns, at least about 5 microns, at least about 10 microns, at least about 20 microns, at least about 50 microns, at least about 100 microns, at least about 200 microns, or at least about 400 microns. In other embodiments, the tube 100 according to embodiments herein may include indication of an improved mechanical property including a surface roughness that is less than about 400 microns, less than about 200 microns, less than about 100 microns, less than about 50 microns, less than about 25 microns, less than about 20 microns, less than about 15 microns, less than about 10 microns, less than about 5 microns, less than about 3 microns, less than about 2 microns, or even less than about 1 micron. In yet another embodiment, the tube 100 according to embodiments herein may include indication of an improved mechanical property including a surface roughness that can be in the range from about 0.1 micron to about 400 microns, from about 0.5 micron to about 100 microns, or from about 1 micron to about 50 microns. It will be further appreciated that the tube 100 according to embodiments herein may include indication of an improved mechanical property including surface roughness that may be any value between any of the minimum and maximum values noted above. In a number of embodiments, the tube 100 according to embodiments herein may include indication of an improved optical property including refractive index between 1.3 and 1.7. In number of embodiments, the tube 100 according to embodiments herein may include indication of an improved optical property including refractive index refractive index of less than 1.60, such as 1.40 to 1.60, such as 1.45 to 1.50. Further, the polymer matrix may be optically clear. In a particular embodiment, the polymer matrix may have an advantageous visible light transmission. For instance, as a tube in a fragrance product, the polymer matrix should have a light transmission that facilitates a desirable, low visibility optical effect of the tube when immersed in and containing a liquid fragrance or when the container is partially empty and the tube is partially exposed in air. For instance, the polymer matrix has a light transmission of greater than about 80%, such as greater than about 85%, such as greater than about 90%, or even greater than about 95%. It will be further appreciated that the tube 100 according to embodiments herein may include indication of an improved optical property including refractive index that may be any value between any of the minimum and maximum values noted above.

In an embodiment, the refractive index of the tube may also be decreased by providing a surface texture on a surface of the tube. Any surface texture that decreases the refractive index of the article is envisioned. In an embodiment, the surface texture has a size and shape that is less than the wavelength of visible light. In an embodiment, the surface texture has a pyramid-like shape, a triangle-like shape, a cylinder shape, a cone shape, a hemisphere shape, or combination thereof. In an example, the surface texture has a height of less than 100 nanometers, such as less than 50 nanometers. In an example, the surface texture has a width of less than 100 nanometers, such as less than 50 nanometers. In a particular embodiment, the surface texture is substantially uniform and does not deviate in thickness of the refractive index modifying layer by more than 30%.

In an embodiment, the tube may include a refractive index domain dispersed within the polymer matrix. A “refractive index domain” as used herein refers to discrete particles or spaces within the polymer matrix. “Discrete” as used herein refers to a particle or space that is not substantially aggregated or interconnected to another particle or space. In particular, the refractive index domain has a refractive index that is lower than the refractive index of the polymer matrix. In an embodiment, the refractive index domain has an advantageous average diameter size. For instance, the refractive index domain has an average diameter size of about 200 nanometer (nm) or less, such as about 5 nm to about 200 nm, such as about 10 nm to about 100 nm, or even about 20 nm to about 60 nm. In a particular embodiment, the average diameter size is less than the wavelength of visible light.

Any refractive index domain is envisioned that decreases the initial refractive index of the tube. For instance, the refractive index domain includes an air bubble, a hollow nanoparticle such as a hollow silica nanoparticle, a hollow polymer nanoparticle, a hollow glass nanoparticle, a hollow ceramic nanoparticle, an aerogel, or combination thereof. For instance, the refractive index domain is an air bubble. The air bubble may be formed by any reasonable method and includes, for example, nano-foaming, using a degradable nanoparticle, or combination thereof.

In an exemplary embodiment, the refractive index domain is a hollow silica nanoparticle. In an embodiment, the refractive index domain is a hollow silica nanoparticle that has desirable properties. In a particular embodiment, the desirable hollow silica particles have one or more of the following characteristics: mesopore-free (for example, a dense solid shell that is free of pores), small diameter (from 20 nm to 200 nm), and/or a shell thickness (from 2 nm to 30 nm).

In another exemplary embodiment, the refractive index domain is an optically transparent aerogel. The aerogel domain is highly transparent due to its small pore sizes (less than 20 nm average diameter). In an embodiment, optically transparent silica aerogel with small primary silica particles (<1 nm diameter) aggregate together to form larger secondary silica particles (−2 nm diameter). These secondary particles bond together to form aerogel with an interconnected necklace structure that supports a highly mesoporous network. The mean pore size is ˜10 nm. The aerogel as a porosity of over 95% and an optical transmittance of 98-99% for visible light. The aerogel is ground into small particles.

In another embodiment, the refractive index domain is a hollow polymer nanoparticle. The polymer shells of the hollow polymeric nanoparticle may be a homopolymer, copolymer, or polymeric blend of a synthetic or nature-derived material. For instance, the hollow polymer nanoparticle includes a polymer shell including a bio-based macromolecule, an amphiphilic polymer, a synthetic polymer, or combination thereof. The polymer shell may or may not be cross-linked. Although not being bound by theory, crosslinking may increase the intramolecular bonds within the material. In an embodiment, the hollow polymer nanoparticle includes a polymer shell including the bio-based macromolecule. Any bio-based macromolecule is envisioned that is biologically-based. For instance, the bio-based macromolecule may be a protein, a lipid, a polypeptide, chitosan, or combination thereof. In another embodiment, the polymer shell includes an amphiphilic polymer. Any amphiphilic polymer is envisioned and includes, for example, a polystyrene-poly(acrylic acid) block copolymer (PS-b-PAAC), a polyethylene oxide-poly(butyl acrylate) block copolymer (EO-b-PBA), or combination thereof. In yet another embodiment, the polymer shell includes a synthetic polymer. Any synthetic polymer is envisioned. In an example, the synthetic polymer includes polysiloxane, polymethyl methacrylate (PMMA), polyvinyl alcohol (PVA), polyvinylidene difluoride (PVDF), polyvinyl chloride (PVC), acrylonitrile butadiene styrene (ABS), polylactic acid (PLA), polydopamine (PDM), polystyrene-poly(methyl methacrylate) copolymer (PS-PMMA), or combination thereof.

In a particular embodiment, the refractive index domain is homogenously dispersed within the polymer matrix. “Homogenous dispersion” refers to a uniform distribution of the refractive index domains throughout the polymer matrix. In an embodiment, the refractive index domain is present in an amount to provide the desirable refractive index for the final tube. Any amount of refractive index domain is envisioned and includes, for example, a volume fraction of about 1% to about 40%, such as about 2% to about 20%, or even about 3% to about 15% based on the total volume of the layer. It will be appreciated that the volume fraction can be within a range between any of the minimum and maximum values noted above.

In a particular embodiment, the layer includes the polymer matrix and the refractive index domain. In an example, the layer may consist essentially of the polymer matrix and the refractive index domain. As used herein, the phrase “consists essentially of” used in connection with the polymer matrix and the refractive index domain of the layer precludes the presence of other monomers that affect the basic and novel characteristics of the layer, although, commonly used processing agents and additives such as antioxidants, fillers, UV agents, dyes, pigments, anti-aging agents, and any combination thereof may be used in the layer. In a particular example, the layer may consist of a polymer matrix and a refractive index domain.

In a particular embodiment, the polymer matrix composition has an advantageous refractive index. For instance, the polymer matrix composition has an initial refractive index (without a refractive index domain, a coating, or a surface texture) of less than 1.45, such as 1.35 to 1.45, or less than 1.43, such as 1.40 to 1.43. Further, the polymer (e.g. silicone) matrix is optically clear. In a particular embodiment, the polymer matrix has an advantageous light transmission. For instance, as a tube in a fragrance product, the tube should have a light transmission that facilitates a desirable, low visibility optical effect of the tube when immersed in and containing a liquid fragrance or when the container is partially empty and the tube is partially exposed in air. For instance, the tube has a visible light transmission of greater than about 80%, such as greater than about 85%, such as greater than about 90%, or even greater than about 95%.

Further, when the refractive index domain is present, the method of providing the refractive index domain is dependent on the refractive index domain chosen. For instance, when the refractive index domain is a hollow silica nanoparticle and a hollow polymer nanoparticle, the nanoparticle is dispersed within the polymer matrix. Dispersion includes mixing the nanoparticle into the polymer matrix. Dispersion of the nanoparticle into the polymer matrix occurs prior to forming the layer into a tube. For example, the nanoparticles are compounded in a polymer matrix through an extruder. Alternatively, the nanoparticles are mixed with a polymer in a liquid state directly (for example, a silicone LSR) or in a polymer-solvent solution. In addition, the nanoparticles can also be dry blended with polymer powders.

When the refractive index domain is an air bubble, the air bubble may be formed with a degradable nanoparticle or via a nano-foaming process. A degradable nanoparticle includes any nanomaterial that degrades under certain conditions, such as heat, pressure, and the like. In an embodiment, any degradable nanoparticle is envisioned and includes, for example, a silicone-polyethylene glycol (PEG) block copolymer, an ammonium bicarbonate encapsulated in a polymeric shell, an ammonium carbonate solution encapsulated in a polymeric shell, or combination thereof. For instance, a silicone-polyethylene glycol (PEG) block copolymer may be dispersed into a polymer matrix, such as a polymer matrix. After the layer is formed, it is heated and the PEG domains decompose at temperature slightly below 200° C. The PEG decomposition creates nano-voids that are well dispersed in the polymer matrix to reduce the refractive index of the tube.

The refractive index domain within the layer may also be formed via nano-foaming. Any nano-foaming method is envisioned. In an embodiment, nano-foaming includes the use of physical blowing agents or by expansion techniques applying a supercritical fluid. During a foaming process using physical blowing agents, the polymer may be saturated with a blowing agent at high pressure, typically in the range of 0.1 to 35 MPa. The polymer/gas mixture may then be quenched into a super-saturated state by reducing pressure, increasing temperature, or combination thereof. Afterwards, nucleation and growth of gas cells dispersed throughout the polymer sample evolve to form a foaming structure. The foaming process can either by continuous (for example, through continuous extrusion process), or batch process (for example, using an autoclave).

When using an expansion technique, applying supercritical fluids, swelling agents or anti-solvent are typically used. Materials with nano-sized porous structures can be formed. Any method is envisioned. For example, solid-state foaming processes may be based on low-temperature carbon dioxide (CO₂) saturation. Any saturation temperature and foaming temperature is envisioned to achieve the desirable pore size and resulting refractive index. Pore size may be tuned for an advantageous refractive index. In an embodiment, the foamed tube may be further treated to render them unwettable. For instance, the foamed tube may be treated with an omniphobic or superomniphobic coating.

In one example, the layer may be formed. The layer may then be treated using supercritical carbon dioxide (CO₂) at various saturation temperatures and foaming temperatures to render the tubing to have an effective refractive index of less than 1.43, such as about 1.34 to about 1.41, such as about 1.36 to about 1.40, or even 1.36 to 1.38. The foamed layer may then be further treated (such as application of omniphobic or superomniphobic coatings) to render it unwettable by alcohols.

In an embodiment the tube consists essentially of a single layer. As used herein, the phrase “consists essentially of” used in connection with the single layer of the tube precludes the presence of other layers that affect the basic and novel characteristics of the refractive index of the final tube. In an embodiment, the tube consists of a single layer.

In an alternative embodiment, the tube includes multiple layers. In an example, the layer including the polymer matrix may be a coating. For instance, the coating layer may be applied on the inner surface, the outer surface, or combination thereof of the tubing. In an embodiment, the coating layer may have a refractive index that is lower than that of a base polymer layer. In an example, the material selected for the base polymer layer may be chosen to provide advantageous properties. Any property is envisioned and depends on the final properties desired for the final article. For instance, the material for the base polymer layer may be selected for an advantageous mechanical strength of the final article. In an embodiment, the base polymer layer may have an advantageous tensile strength to provide the final article with a desirable tensile modulus in combination with desirable refractive index. Any non-polymer with a desirable initial refractive index (with or without any refractive index domain dispersed therein) is envisioned. An exemplary polymer may be formed of a homopolymer, copolymer, terpolymer, or polymer blend formed from a silicone polymer, a polyolefin, a polycarbonate, a cellulose triacetate, a cellulose ester, a polymethyl methacrylate, an epoxy, a cyclic olefin copolymer, a polyvinyl chloride, an amorphous copolyester, a polyethylene terephthalate, an ionomer resin, an acrylonitrile butadiene styrene (ABS), a styrene methyl methacrylate, a polystyrene, or combination thereof. In a particular embodiment, the polymer matrix includes a silicone polymer, a polyolefin, a polycarbonate, a cellulose triacetate, a cellulose ester, or combination thereof. In a more particular embodiment, the silicone polymer is a liquid silicone rubber (LSR), a high consistency gum rubber (HCR), and the like. In an embodiment, the base polymer layer has a desirable visible light transmission, such as greater than about 80%, such as greater than about 85%, such as greater than about 90%, or even greater than about 95%.

In another embodiment, a coating is applied on the tube to decrease the refractive index. For instance, the coating includes a multilayer polyelectrolyte coating, an alcogel coating, or combination thereof on a base polymer layer of the polymer matrix as described above. An “alcogel” as used herein refers to a polymer that is swellable or soluble in alcohol. In an embodiment, the polymer may be crosslinked, such as physically crosslinked or chemically crosslinked. In a particular embodiment, the degree of crosslinking determines the degree of swelling. In a more particular embodiment, when crosslinked, the alcogel is insoluble in alcohol. In an embodiment, the polymer may be linear, non-linear, or combination thereof. In an embodiment, the polymer may be hydrophilic. An alcogel coating includes a polymer and an alcohol. In an embodiment, any polymer that is swellable or soluble in alcohol is envisioned, wherein the polymer includes silicone, polyvinyl alcohol (PVA), polyethylene glycol (PEG), polyvinyl alcohol-polyethylene glycol (PVA-PEG), poly-2-acrylamido-2-methyl-1-propanesulfonic acid (PAMPS), polyacrylic acid (PAA), polyacrylamide (PAAm), poly(ethylene glycol) methyl ether methacrylate, poly(ethylene glycol) methyl ether acrylate, poly(ethylene glycol) methyl ether dimethacrylate, polyvinyl amine, or combination thereof. In an embodiment, the polyethylene glycol may be linear, non-linear, or combination thereof. Typical alcohols include methanol, ethanol, isopropanol, or combination thereof. Typically, the volume percentage of the alcohol in the alcogel is at least 10%, such as at least 50%, or even at least 90%. When immersed in perfume, the alcohol has a volume content of about 10 volume % to about 90 volume % when the alcogel is immersed in perfume. The alcogel may further include a crosslinker.

Any thickness of the alcogel coating is envisioned depending on the material chosen and the final properties desired for the article, such as the fragrance tube. For instance, the alcogel coating has a thickness of about 10 nanometers to 100 micrometers, or even 100 nanometers to 100 micrometers in a dry state. In a particular embodiment, the alcogel coating is substantially uniform in a dry state. For instance, the alcogel coating does not deviate in thickness by greater than 30% in a dry state. The alcogel coating may be applied by any method envisioned and includes, for instance, dip coating, spray coating, atmospheric plasma enhanced polymerization, film coating, or combination thereof. In an embodiment, the alcogel is crosslinked. Any method of crosslinking is envisioned and includes, for example, crosslinking the alcogel in place using a variety of techniques such as via heat, radiation, UV irradiation, with a UV curing agent, a crosslinking agent, plasma, or any combination thereof. A crosslinking agent includes, for instance, a diacrylate, a dimethylacrylate, or combination thereof. In a particular embodiment, the alcogel coating is on an outer surface of the fragrance tube, an inner surface of the fragrance tube, or combination thereof.

Returning to FIG. 1B, the substrate 102 has the same refractive index as the coating 104. For example, the total thickness of the layers of the multilayer tube 100 may be the same as the thickness described for the single layer tube 100 of FIG. 1. In an embodiment, the substrate 102 has a thickness in a range of about 0.01 mm to about 0.40 mm, such as a range of about 0.03 mm to about 0.12 mm. The base polymer layer 206 and coating 104 may make up the difference. In an embodiment, the coating 104 has a thickness that is the same as the thickness of the substrate 102. In an embodiment, the coating 104 has a thickness that is different as the thickness of the substrate 102, with the proviso that the coating 104 and the substrate 102 have the same refractive index. In an example, the coating 104 may have a thickness in a range of about 0.01 mm to about 0.40 mm, such as a range of about 0.03 mm to about 0.12 mm. In a more particular embodiment, the substrate 102 has a thickness that is greater than the base polymer layer 206. In an example, the substrate 102 and the coating 104 each have a thickness that is greater than the thickness of the base polymer layer 206. In an embodiment, the thickness of the base polymer layer 206 is greater than a thickness of the substrate 102, coating 104, or combination thereof. For instance, the base polymer layer 206 may have a thickness of about 0.01 mm to about 0.40 mm, such as a range of about 0.02 mm to about 0.12 mm. It will be appreciated that the thickness values can be within a range between any of the minimum and maximum values noted above.

In a particular embodiment, any method of forming the layers is envisioned to provide for a multilayer tube and is dependent on the material chosen for each layer. Any order of forming the layers is envisioned. When present, any method of providing a refractive index domain in any of the layers is envisioned. For instance, a base polymer layer may be provided that includes the polymer matrix. In an example, the base polymer layer is extruded, injection molded, or mandrel wrapped. In an exemplary embodiment, the base polymer layer is extruded. Further, the layer may be cured in place using a variety of curing techniques such as via heat, radiation, or any combination thereof. When present, the refractive index domain in the base polymer layer may be provided by any method described.

In a number of embodiments, the tube 100 may be substantially transparent to visible light. A variety of degrees of transparency are suitable, as it will be appreciated that the transparency of the tube 100 is a function of the aesthetics desired for particular applications.

In a number of embodiments, a method may include providing a substrate including a composition including a silicone polymer, an inorganic filler, a cross-linking component, and a catalyst. The method may further include forming a sidewall from the substrate, the sidewall defining a lumen profile along a central axis to form a tube, where the tube has a minimum tensile strength of 12 MPa, where the tube has a minimum tear strength of 15 N/mm, where the tube has a minimum toughness of 0.26 MPa, and where the tube has a minimum tensile modulus of 120 MPa.

Although generally described as a tube, any reasonable article can be envisioned. The article may alternatively take the form of a film, a washer, or a fluid conduit. For example, the article may take the form of a film, such as a laminate, or a planar article, such as a septa or a washer. In another example, the article may take the form of a fluid conduit, such as tubing, a pipe, a hose or more specifically flexible tubing, transfer tubing, pump tubing, chemical resistant tubing, high purity tubing, smooth bore tubing, a polymer lined pipe, or rigid pipe, or any combination thereof. In a number of embodiments, the tube can be used as tubing or hosing where chemical resistance and transparency is desired. For instance, a tubing is a pump tube, such as for liquid dispensing, a peristaltic pump tube, or a liquid transfer tube, such as a chemically resistant liquid transfer tube.

Applications for the tubing are numerous. In an exemplary embodiment, the tubing may be used in applications such a cosmetic product, household wares, industrial, wastewater, digital print equipment, automotive, medical care (e.g. medical tubes), health care, biopharmaceutical, pharmaceutical, drinking water, personal care, food & beverage, fluid transfer, aerospace, vehicle, habitat industry, laboratory, dairy or other applications where transparency, clarity, chemical resistance, mechanical integrity, and/or low permeation to gases and hydrocarbons are desired.

According to embodiments herein, tube 100 are provided that may provide improved performance in chemical inertness, biocompatibility, elasticity, coefficient of friction, contamination resistance, and other mechanical properties, antibacterial properties, antiviral properties, and antifungal properties while maintaining heat and chemical resistance for their desired application (particularly versus existing tubes).

In a number of embodiments, the tube according to embodiments herein may exhibit an optimized relationship between mechanical properties (e.g. impact strength and resistance) and optical properties (e.g. transparency and haze) while maintaining sustainability and biocompatibility within a desired application that existing tubes (e.g. fluoropolymers) cannot achieve, particularly in medical tubing products. This may prove for a sustainable product to provide adequate lifetime of the product due to lessened failures in metrics such as impact strength, chemical resistance, and long-term stability during storage, shipment, and use of the product under a variety of conditions while maintaining biocompatibility and sustainability.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1: A tube comprising: a substrate forming a sidewall defining a lumen profile along a central axis, wherein the substrate comprises a composition comprising a silicone polymer, an inorganic filler, a cross-linking component, and a catalyst, wherein the tube has a minimum yield strain of 5%, wherein the tube has a minimum tensile strength of 12 MPa, wherein the tube has a minimum tear strength of 15 N/mm, wherein the tube has a minimum toughness of 0.26 MPa, and wherein the tube has a minimum tensile modulus of 120 MPa.

Embodiment 2: A method comprising: providing a substrate comprising composition comprising a silicone polymer, an inorganic filler, a cross-linking component, and a catalyst; and forming a sidewall from the substrate, the sidewall defining a lumen profile along a central axis to form a tube, wherein the tube has a minimum tensile strength of 12 MPa, wherein the tube has a minimum tear strength of 15 N/mm, wherein the tube has a minimum toughness of 0.26 MPa, and wherein the tube has a minimum tensile modulus of 120 MPa.

Embodiment 3: The tube or method according to any one of the preceding embodiments, wherein the silicone polymer comprises MQ resin.

Embodiment 4: The tube or method according to any one of the preceding embodiments, wherein the inorganic filler comprises high specific surface area (>150-360 m²/g) fumed silica.

Embodiment 5: The tube or method according to any one of the preceding embodiments, wherein the cross-linking component comprises interpenetrating crosslinking networks.

Embodiment 6: The tube or method according to embodiment 3, wherein the catalyst comprises Pt based catalyst.

Embodiment 7: The tube or method according to embodiment 3, wherein a tube has a Shore hardness greater than 80 Shore A and less than 65 Shore D.

Embodiment 8: The tube or method according to any one of the preceding embodiments, wherein the tube has a thickness of at least 0.1 mm, at least 50 mm, at least 100 mm, at least 200 mm, at least 250 mm, or at least 500 mm.

Embodiment 9: The tube or method according to any one of the preceding embodiments, wherein the tube has a thickness in a range from 25 mm to 250 mm, in a range from 50 mm to 200 mm, in a range from 100 mm to 150 mm, or in a range from 100 mm to 125 mm.

Embodiment 10: The tube or method according to any one of the preceding embodiments, wherein the inorganic filler has a surface area of 150-360 m²/g.

Embodiment 11: The tube or method according to any one of the preceding embodiments, wherein the catalyst has a platinum masterbatch wt. % of 0.5-2 wt. %.

Embodiment 12: The tube or method according to any one of the preceding embodiments, wherein the substrate has content of silicone polymer of at least 20 wt. %, at least 30 wt. %, at least 40 wt. %, at least 50 wt. %, at least 60 wt. %, at least 70 wt. %, at least 75 wt. %, at least 80 wt. %, at least 85 wt. %, or at least 90 wt. %, or at least 95 wt. %.

Embodiment 13: The tube or method according to any one of the preceding embodiments, wherein the substrate has content of silicone polymer of no greater than 95 wt. %, no greater than 90 wt. %, no greater than 85 wt. %, no greater than 80 wt. %, no greater than 75 wt. %, no greater than 70 wt. %, no greater than 65 wt. %, no greater than 60 wt. %, no greater than 55 wt. %, or no greater than 50 wt. %.

Embodiment 14: The tube or method according to any one of the preceding embodiments, wherein the substrate has content of inorganic filler of at least 5 wt. % or at least 15 wt. %.

Embodiment 15: The tube or method according to any one of the preceding embodiments, wherein the tube or method has a circular or oval cross-section down a central axis.

Embodiment 16: The tube or method according to any one of the preceding embodiments, wherein the tube or method has an inner diameter, ID, wherein the inner diameter is at least 0.1 mm or at least 1.5 mm.

Embodiment 17: The tube or method according to any one of the preceding embodiments, wherein the tube or method has an outer diameter, OD, wherein the outer diameter is at least 0.2 mm or at least 1.8 mm.

Embodiment 18: The tube according to any one of the preceding embodiments, wherein the tube comprises structures having a lumen through which a fluid may be carried, pumped, or otherwise transported through.

Embodiment 19: The method according to embodiment 2, wherein the forming process comprises an extrusion or molding process.

Embodiment 20: The tube according to any one of the preceding embodiments, wherein the inorganic filler further comprises glass fiber.

Embodiment 21: The tube according to embodiment 20, wherein the glass fiber is in a wt. % of at least 5% and no greater than 40% wt. %.

### EXAMPLES

The following examples are provided to better disclose and teach processes and compositions of the present invention. They are for illustrative purposes only, and it must be acknowledged that minor variations and changes can be made without materially affecting the spirit and scope of the invention as recited in the claims that follow.

Example 1: A commercially available HCR, Wacker-3 was used as the silicone polymer base for the polymer matrix. 10 wt. % of high surface area fumed silica was mixed in a Flacktek© Speedmixer with Wacker-3, a cross-linking component, and a platinum catalyst. The sample was further milled on a two-roll mill machine to well disperse the composition. The milled HCR was cured for about 15 minutes at about 150° C. to form a silicone slab that would be formed into a tube according to embodiments herein. The final thickness of the silicone slab was measured to be 2.0 mm. This silicone slab exhibiting an optimal and critical tear strength (N/mm) of 18.6+/−0.2 compared to a tear strength of 12.6+/−0.8 for existing tubing according to conventional methods and materials that did not include 10 wt. % of high surface area fumed silica.

Example 2: A high-consistency rubber (HCR) silicone composition according to embodiments herein was prepared by incorporating high SSA (>200 m²/g) fumed silica into HCR using a speed mixer to achieve initial dispersion. The mixture was then processed on a two-roll mill to ensure uniform distribution and optimal filler integration. Platinum catalyst was subsequently added via the two-roll mill to initiate crosslinking. The compound was molded into a tube according to embodiments herein and cured at about 185° C. for about 30 minutes, followed by a post-curing step at about 200° C. for about 4 hours to enhance thermal stability and mechanical performance. The mechanical properties are evaluated by ASTM D412 and are shown in TABLE 1 and TABLE 2 below.

TABLE 1

| | Tear Strength | Silica | |
|---|---|---|---|
| Sample | (N/mm) | Loading | Improve % |
| Control Reference | 12.66 ± 0.8 | — | — |
| (No Silica) | | | |
| Sample 1 | 13.9 ± 0.7 | 1% | 9.7% |
| Sample 2 | 15.4 ± 0.4 | 3% | 21.6% |
| Sample 3 | 15.2 ± 0.4 | 5% | 20.1% |
| Sample 4 | 17.0 ± 0.2 | 7% | 34.3% |
| Sample 5 | 18.6 ± 0.2 | 10% | 46.9% |
| Sample 6 | 15.5 ± 1.5 | 15% | 22.0% |
| Sample 7 | 9.7 ± 3.2 | 20% | −24% |

TABLE 2

| | Tensile Strength | | Elastic Modulus |
|---|---|---|---|
| Sample | (MPa) | Elongation Break | (MPa) |
| Control | 15.4 | 160% | 131 |
| Reference | | | |
| Sample 5 | 19.1 | 83% | 231 |
| Sample 6 | 19.6 | 67% | 282 |
| Sample 7 | 12.5 | 33% | 384 |

As shown in TABLE 1, use of High SSA silica fillers in compositions and/or tubes according to embodiments herein offers improved tear strength at an optimal and critical loading weight % of greater than 1% and less than 15%, such as greater than 3% and less than 10%, or such as greater than 5% and less than 10%, or such as greater than 7% and less than 10%. As shown in TABLE 2, use of High SSA silica fillers in compositions and/or tubes according to embodiments herein offers improved tensile strength, elongation at break, and elastic modulus at an optimal and critical loading weight % of greater than 10 wt. % and less than 20 wt. %, such as greater than 10 wt. % and less than 15 wt. %, or such as or greater than 15 wt. % and less than 20 wt. %.

Example 3: A 70 Duro HCR silicone composition according to embodiments herein was prepared by incorporating glass fiber (having an average fiber length of about 300 μm and an average cross-sectional diameter of about 11 μm) into silicone gum HCR using a Brabender C mixer operated for 20 minutes to achieve thorough dispersion. The resulting compound was then processed on a two-roll mill to ensure uniform filler distribution and optimal consistency. Peroxide catalyst was subsequently added via the two-roll mill to initiate crosslinking. The resulting compound was molded into a tube according to embodiments herein and cured at about 200° C. for about 10 minutes, followed by post-curing at about 250° C. for about 4 hours to enhance thermal stability and mechanical performance. This method yields a durable silicone elastomer suitable for demanding applications. The mechanical properties are evaluated by ASTM D412 and are shown in TABLE 3 below.

TABLE 3

| | Tensile | Elastic | Elonga- | Tear | Hard- |
|---|---|---|---|---|---|
| | Strength | Modulus | tion | Strength | ness |
| Sample | (MPa) | (MPa) | Break | (N/mm) | (ShA) |
| Control | 4.7 ± 1.1 | 6.5 ± 0.03 | 264.45% | 12.0 ± 0.8 | 66 |
| Refer- | | | | | |
| ence | | | | | |
| Sample 1 | 3.2 ± 0.67 | 9.6 ± 0.9 | 213.07% | 11.4 ± 1.0 | 64 |
| (5 wt. % | | | | | |
| glass | | | | | |
| fiber) | | | | | |
| Sample 2 | 6.5 ± 0.3 | 20.6 ± 3.2 | 308.40% | 23.5 ± 2.1 | 76 |
| (9.1 wt. % | | | | | |
| glass | | | | | |
| fiber) | | | | | |

As shown in TABLE 3, use of glass fiber fillers in compositions and/or tubes according to embodiments herein offers improved tensile strength, elongation at break, and elastic modulus at an optimal and critical loading weight % of greater than 5 wt. % and less than 10 wt. %.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A tube comprising:
a substrate forming a sidewall defining a lumen profile along a central axis, wherein the substrate comprises a composition comprising a silicone polymer, an inorganic filler, a cross-linking component, and a catalyst, wherein the tube has a minimum yield strain of 15%, wherein the tube has a minimum tensile strength of 12 MPa, wherein the tube has a minimum tear strength of 5 N/mm, wherein the tube has a minimum toughness of 0.26 MPa, and wherein the tube has a minimum tensile modulus of 120 MPa.

2. A method comprising:
providing a substrate comprising composition comprising a silicone polymer, an inorganic filler, a cross-linking component, and a catalyst; and
forming a sidewall from the substrate, the sidewall defining a lumen profile along a central axis to form a tube, wherein the tube has a minimum yield strain of 5%, wherein the tube has a minimum tensile strength of 12 MPa, wherein the tube has a minimum tear strength of 15 N/mm, wherein the tube has a minimum toughness of 0.26 MPa, and wherein the tube has a minimum tensile modulus of 120 MPa.

3. The tube according to claim 1, wherein the silicone polymer comprises MQ resin.

4. The tube according to claim 1, wherein the inorganic filler comprises high specific surface area (>150-360 m²/g) fumed silica.

5. The tube according to claim 1, wherein the cross-linking component comprises interpenetrating crosslinking networks.

6. The tube according to claim 3, wherein the catalyst comprises Pt based catalyst.

7. The tube according to claim 3, wherein a tube has a Shore hardness greater than 80 Shore A and less than 65 Shore D.

8. The tube according to claim 1, wherein the tube has a thickness of at least 0.1 mm.

9. The tube according to claim 1, wherein the tube has a thickness in a range from 25 mm to 250 mm.

10. The tube according to claim 1, wherein the inorganic filler has a surface area of 150-360 m²/g.

11. The tube according to claim 1, wherein the catalyst has a Platinum masterbatch wt. % of 0.5-2 wt. %.

12. The tube according to claim 1, wherein the substrate has content of silicone polymer of at least 20 wt. %.

13. The tube according to claim 1, wherein the substrate has content of silicone polymer of no greater than 95 wt. %.

14. The tube according to claim 1, wherein the substrate has content of inorganic filler of at least 5 wt. %.

15. The tube according to claim 1, wherein the tube or method has a circular or oval cross-section down a central axis.

16. The tube according to claim 1, wherein the tube or method has an inner diameter, ID, wherein the inner diameter is at least 0.1 mm.

17. The tube according to claim 1, wherein the tube or method has an outer diameter, OD, wherein the outer diameter is at least 0.2 mm.

18. The tube according to claim 5, wherein the inorganic filler further comprises glass fiber.

19. The tube according to claim 18, wherein the glass fiber is in a wt. % of at least 5% and no greater than 40% wt. %.

20. The tube according to claim 1, wherein the tube has a minimum yield strain of 10%, such as 15%.
